(19) United States
(12) Patent Application Publication
(10) Pub. No.: US 2009/0300226 A1
(43) Pub. Date: Dec. 3, 2009

(54) SYSTEM AND METHOD FOR DYNAMIC DISCOVERY OF NETWORKED PRINTING DEVICES

(75) Inventor: Ramon Rubio, Downey, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/130,930

(22) Filed: May 30, 2008

(51) Int. Cl. G06F 3/00

(52) U.S. Cl. 710/10

(57) ABSTRACT

The invention relates to multifunction peripherals (MFPs). More particularly, the invention relates to dynamic discovery of networked printing devices. Some embodiments of the invention include multi-function peripherals capable of broadcasting their respective physical location to recipient devices capable of generating a map to the respective device based on the physical location.

### BACKGROUND OF THE INVENTION

1. Field of the Invention

The invention relates to multi-function peripherals (MFPs). More particularly, the invention relates to dynamic discovery of networked printing devices.

2. Description of the Related Art

Multifunction peripheral devices are often available in networks covering a substantial amount of physical space. Some networks provide device identification over the network, allowing users to discover devices available for use. Some networks may also provide static maps showing users the physical location of the devices. These static maps may be kept in a central location and updated whenever one of the devices is moved to a new physical location. Thus, a user can search the network for an available device, and can locate where the device resides on a map. Users are responsible for determining how to locate the device using the static map. Furthermore, administrators are responsible for updating the maps if the device locations change. Hence, there is a need to improve the capabilities of multifunction peripherals to provide their respective physical location to users.

### SUMMARY OF CERTAIN INVENTIVE ASPECTS

In general, aspects of the invention relate to multifunction peripherals (MFPs). More particularly, aspects of the invention relate to dynamic discovery of physical location of networked printing devices.

One aspect is a method for dynamic discovery of a networked peripheral device comprising: determining a physical location of a multifunction peripheral device; communicating the physical location from the multifunction peripheral device to a recipient computing device; receiving the physical location at the recipient computing device; and generating a map based on the physical location of the multifunction device.

Another aspect is a computer readable medium having instructions stored thereon for dynamic discovery of a networked peripheral device. The instructions may comprise: determining a physical location of a multifunction peripheral device; communicating the physical location from the multifunction peripheral device to a recipient computing device; receiving the physical location at the recipient computing device; and generating a map based on the physical location.

Still another aspect is a system for dynamic discovery of a networked peripheral device comprising: a multifunction peripheral device configured to communicate its physical location; and a computer readable medium having instructions stored thereon for generating a map based on the physical location of the multifunction peripheral device, the instructions comprising receiving the physical location and generating a map based on the physical location.

Yet another aspect is a multifunction peripheral device configured to communicate its physical location comprising: a chassis housing a plurality of device modules comprising at least one of the following: a printer, a fax module, a scan module, and a copier; a computer readable medium having data stored thereon for storing the physical location of the chassis; and a communication module configured to communicate the physical location to a recipient computing device.

Another aspect is A method of generating a list of suitable multifunction peripherals, based at least in part on physical locations of multifunctional peripherals available over a network comprising: receiving device requirements from a user, wherein the device requirements include an acceptable range of physical distance from the user; determining a list of available multifunction peripherals from which to determine a list of suitable devices; eliminating from the list devices that are not within the physical distance specified by the device requirements; eliminating from the list devices that do not meet the other device requirements; and sending the list of multifunction peripherals that are within the specified physical distance and that meet the other device requirements.

### BRIEF DESCRIPTION OF THE DRAWINGS

FIG. 1 illustrates one embodiment of a network that includes multifunction peripherals accessible over the network.

FIG. 2A illustrates one embodiment of a network that includes multifunction peripherals whose physical locations are discoverable via static maps.

FIG. 2B illustrates one embodiment of a network that includes multifunction peripherals whose physical locations may be discovered dynamically.

FIG. 3 illustrates one embodiment of a user computer dynamically discovering the physical location, capabilities, and cost of a multifunction peripheral over a network.

FIG. 4 illustrates one embodiment of a process of dynamically discovering the physical location of a multifunction peripheral device.

FIG. 5 illustrates one embodiment of a process for creating a list of available multifunction peripherals by dynamically discovering the physical location of available devices.

These and other features will now be described with reference to the drawings summarized above. The drawings and the associated descriptions are provided to illustrate embodiments of the invention and not to limit the scope of the invention. Throughout the drawings, reference numbers may be reused to indicate correspondence between referenced elements. In addition, the first digit of each reference number generally indicates the figure in which the element first appears.

### DETAILED DESCRIPTION OF CERTAIN PREFERRED EMBODIMENTS

Various aspects and features of the invention will become more fully apparent from the following description and the pending claims taken in conjunction with the foregoing drawings. In the drawings, like reference numerals indicate identical or functionally similar elements. The drawings, associated descriptions, and specific implementations are provided to illustrate the embodiments of the invention, but not to limit the scope of the disclosure.

In many networked environments, it is desirable to provide a user with the identities of devices available for common services such as printing. Thus, many networks provide users with information regarding available multifunction peripherals (MFPs). For example, a university may provide students, faculty, employees, guests, and others with access to multifunction peripherals available throughout the university, or a particular building department, geographical area, dormitory, and so forth. One skilled in the art will appreciate that there are many suitable ways to discovery available devices, including their network addresses, such as an Internet protocol (IP) address.

It is often desirable to also know the physical location of such devices. Users who submit jobs over the network may need to retrieve the work product from the networked device. In addition, for some functions of multifunction peripherals, users may not be able to submit their jobs over the network, but instead need to submit their jobs at a device's physical interface. Hence, it is desirable to provide the physical location of the device.

One way to provide the physical location of the device is to record a map of the surrounding area, such as the university, a building, a geographical area, and so forth. These recorded maps may be stored in a digital medium that may be accessed over the network. Hence, a user desiring to know the physical location of a particular device may retrieve a digital copy of the map and use the map to determine how to arrive at the device. A static map does not provide a user with any information regarding the user's location relative to the device location. Furthermore, static maps must be updated whenever a device is moved from its physical location. If a device is moved without obtaining the relevant map, users may discover incorrect information, leading to inefficiencies and frustration.

One possible solution to the above-mentioned problems is to provide for dynamic discovery of networked devices. Hence, embodiments of the invention include systems, methods, and software for dynamically discovering networked printing devices.

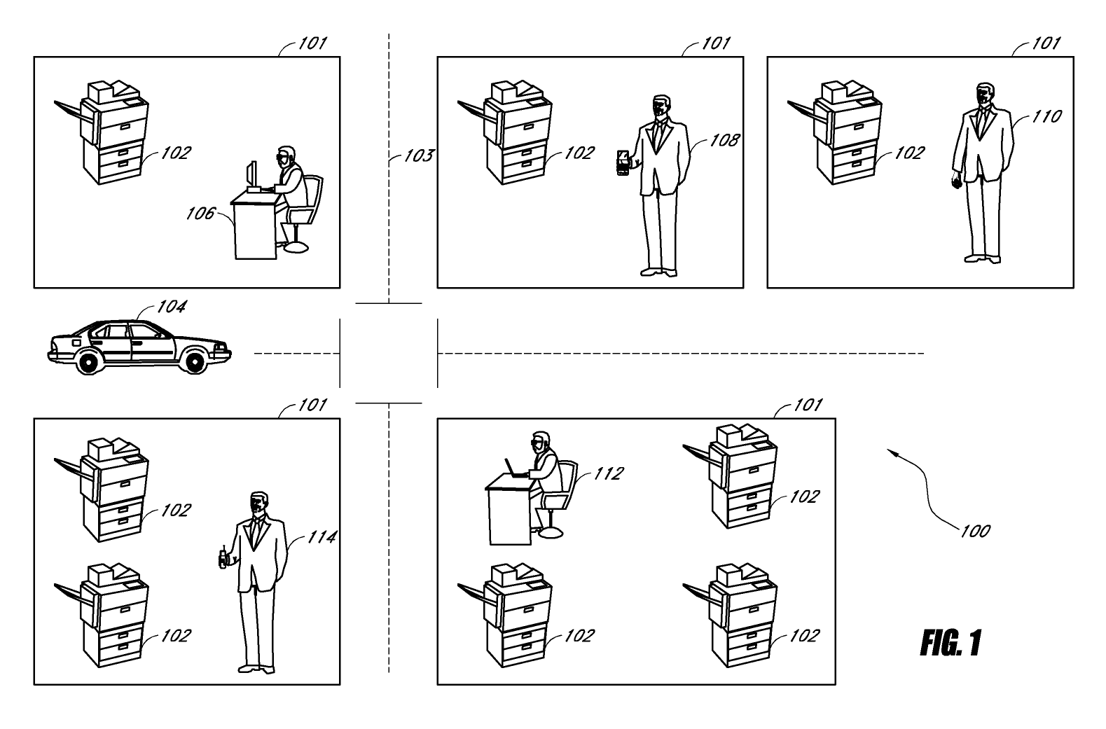

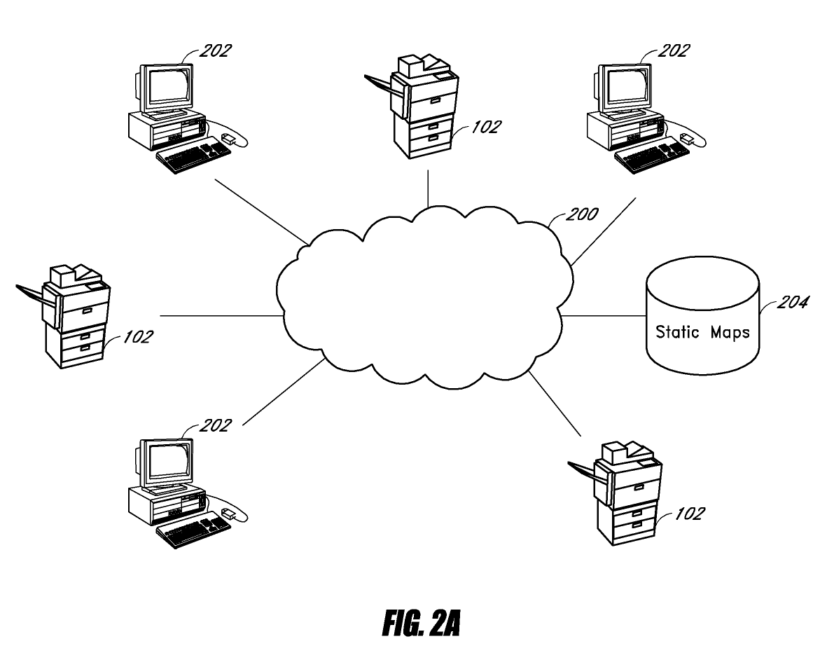

FIG. 1 illustrates an embodiment in which dynamic discovery of networked devices may be advantageous. FIG. 1 illustrates a group of buildings in a university setting. The university 100 comprises five buildings 101 separated by streets 103. Inside buildings 101 are various multifunction peripheral devices (MFPs) 102. These MFPs may have different functions and capabilities. Furthermore, the MFPs may have different costs associated with their use and/or may have different access privileges for different members of the university community. For example, some MFPs may be accessible only to administrators or faculty. As another example, some MFPs may be free of charge while others cost a certain amount of money to use. In addition, some MFPs may have color printing capabilities while others provide faxing, scanning, or other different functions that are not available on some or all of the remaining MFPs. Thus, it is desirable for members of the university 100 community to be able to locate different devices and to know their capabilities, costs, and privileges, for example.

In a networked community, users of MFPs may locate available devices via numerous computing devices. For example, a user in an automobile may use an onboard computer 104 to locate available devices. A desktop user 106, a personal digital assistant (PDA) user 108, a laptop user 112, and a cell phone user 114, may all similarly discover available devices over the university network. Furthermore, an MFP 102 device user 110 may use an MFP 102 to discover other available MFPs and their associated physical locations, capabilities, costs, and privileges, for example.

In a spread out geographical environment such as a university, it is desirable to know the physical locations of devices in addition to the network addresses of such devices. Hence, a university is an example of a setting in which it may be advantageous to provide for dynamic discovery of networked printing devices. Although in the illustrated embodiments a university setting has been described, there are other suitable settings including, for example, a business compound, a group of retail service providers that offer printing and other office services, a government institution, a hospital, an office building, a community college, and so forth.

In general, an MFP device is a single integrated device configured to perform two or more functions, including, without limitation, scanning, copying, printing, faxing, combinations of the same, and the like. The functionality of an MFP device may be accessed over a network, including, for example, the Internet, or a LAN, or at the device itself. An MFP device may be configured with sufficient memory to queue jobs waiting to be processed. It will be appreciated that MFP devices may be configured to perform in a variety of different network and standalone computing environments. Although some of the embodiments described herein relate to an MFP device, other embodiments may be implemented with other peripheral devices, such as single-function devices, including for example printers and scanners.

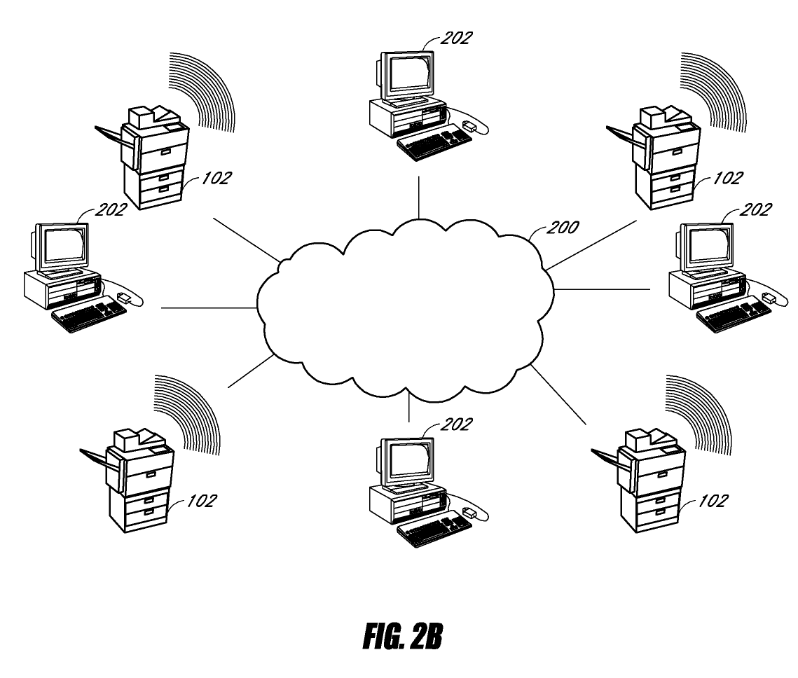

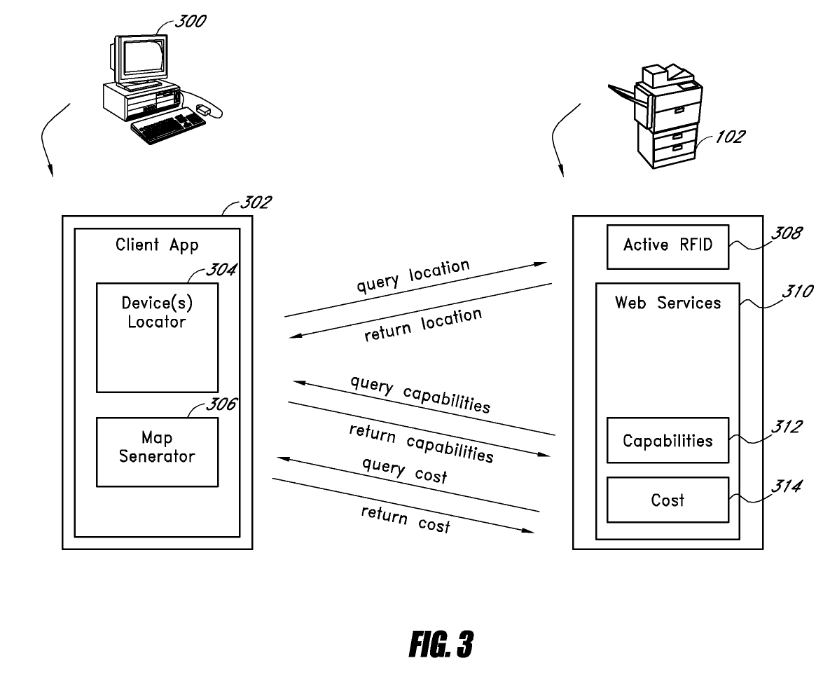

FIG. 2A illustrates one embodiment of networked MFPs that utilize static maps to provide device locations. Network 200 connects MFPs 102 and computing devices 202. Users may access MFPs 102 either through physical interfaces on the devices themselves or by accessing them remotely through computing devices 202. A central collection of static maps 204 provides digital copies of the physical locations of the devices for those users accessing the MFPs 102 remotely. The static maps 204 may be updated periodically to describe the changes in the physical location of particular devices.

FIG. 2B illustrates one embodiment of a networked group of MFPs that provide dynamic discovery of their physical locations. Network 200 connects MFPs 102 with computing devices 202. Users accessing the MFPs 102 via computing devices 202 may dynamically discover the physical locations of MFPs 102. MFPs 102 broadcast, in some embodiments, their physical locations to receiving computing devices 202. By using software to receive the physical locations and generate maps, users of computing devices 202 may determine how to arrive at the MFPs 102. Furthermore, when MFPs are moved they begin to broadcast their new locations by determining their new location upon arrival. It may be unnecessary, therefore, to maintain and update the location of the MFPs on static maps.

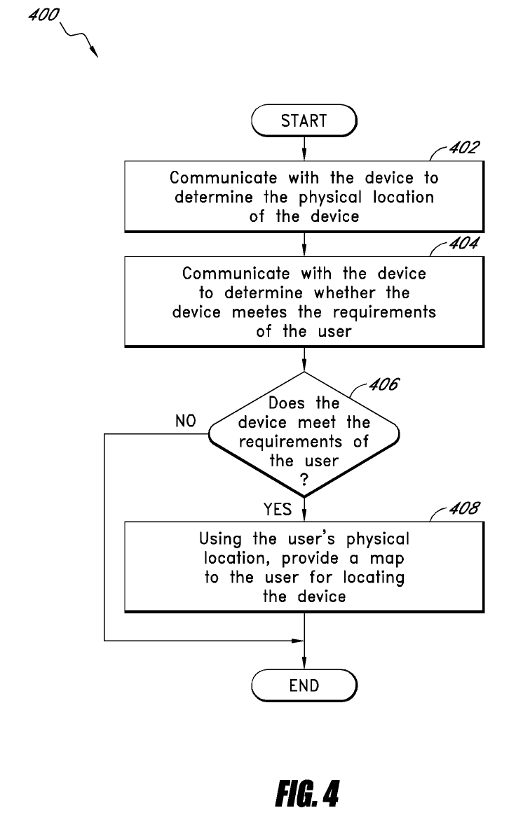

FIG. 3 illustrates one embodiment of a client computer dynamically discovering the physical location of an MFP. A user accesses MFP 102 via client computer 300 over a network. Client computer 300 includes a client application 302 that includes a device locator 304 and a map generator 306. The MFP 102 includes an active RFID component 308 and Web services 310, which include a capabilities service 312 and a cost service 314. In some embodiments, client application 302 is a client application that interfaces with a corresponding server application. Those skilled in the art will appreciate how to implement a client-server architecture to build embodiments of the invention. Additionally and/or alternatively, client application 302 may be an application executing in a Web browser, and one or more of the components of client application 302 may be provided as Web services.

Using client application 302, the client computing device 300 queries the location of MFP 102. MFP 102 uses active RFID component 308 to broadcast the physical location of MFP 102. An active RFID component uses radio-frequency identification technology to send radio frequency broadcasts to devices within range capable of receiving the broadcasts. One skilled in the art will appreciate that many suitable RFID technologies may be used to implement embodiments of the invention, including active RFID, in which the RFID component includes an independent battery source for broadcasting. One skilled in the art will also appreciate that other technologies may also be used to broadcast the location of MFP 102.

MFP 102 may know its physical location because of device locator 304, which may be a global positioning system (GPS) or by some location determining device. A GPS device uses a network of satellites to locate its longitude and latitude. One skilled in the art will appreciate that there are other suitable ways to determine physical location, including using cell phone towers or statically updating a physical location to the device itself MFP 102 may broadcast its longitude and latitude to receiving devices. Using active RFID component 308, therefore, MFP 102 can broadcast its longitude and latitude to client computer 300.

After determining the physical location of MFP 102, client application 302 can use map generator 306 to generate a map for the user. The map generator 306 may utilize a GPS system to determine the longitude and latitude of the client's computing device 300. Alternatively, the device user may enter the physical location of the client device 300. Using the latitude and longitude of the client computer 300 and the MFP 102, the map generator 306 may deliver a map with precise instructions for locating the MFP device 102. Moreover, as the client device 300 moves relative to the MFP 102, the map generator may dynamically update the map as well as the directions for arriving at the MFP device. Although in the illustrated embodiment, the map generator 306 generates a map from the location of the device user to the MFP 102, in other embodiments, the client application 302 may provide only the location of the MFP 102 without determining the physical location of the client device 300. Although in the illustrated embodiment the client application 302 resides on the client device 300, in other embodiments the functionality of client application 302 may be provided by a Web service hosted on MFP 102 or hosted on a server computer, such as a university server that manages access to multifunction peripherals available in the university network. For example, the client application 302 might use a Web service that provides a map generator similar to the functionality of map generator 306.

In addition to determining the physical location, the client computer 300 may also access the Web services 310 available on MFP 102. For example, the client device 300 may query the capabilities and/or the cost of using MFP 102. MFP 102 can return the capabilities and the cost of using its device. In other embodiments, Web services 310 may also provide a user with an interface to device privileges, and permit and/or deny access based on such privileges. Although in the illustrated embodiment Web services 310 are illustrated as residing on MFP 102, in other embodiments Web services 310 may be provided by a separate server, such as a university server that manages access to multifunction peripherals available in the university network.

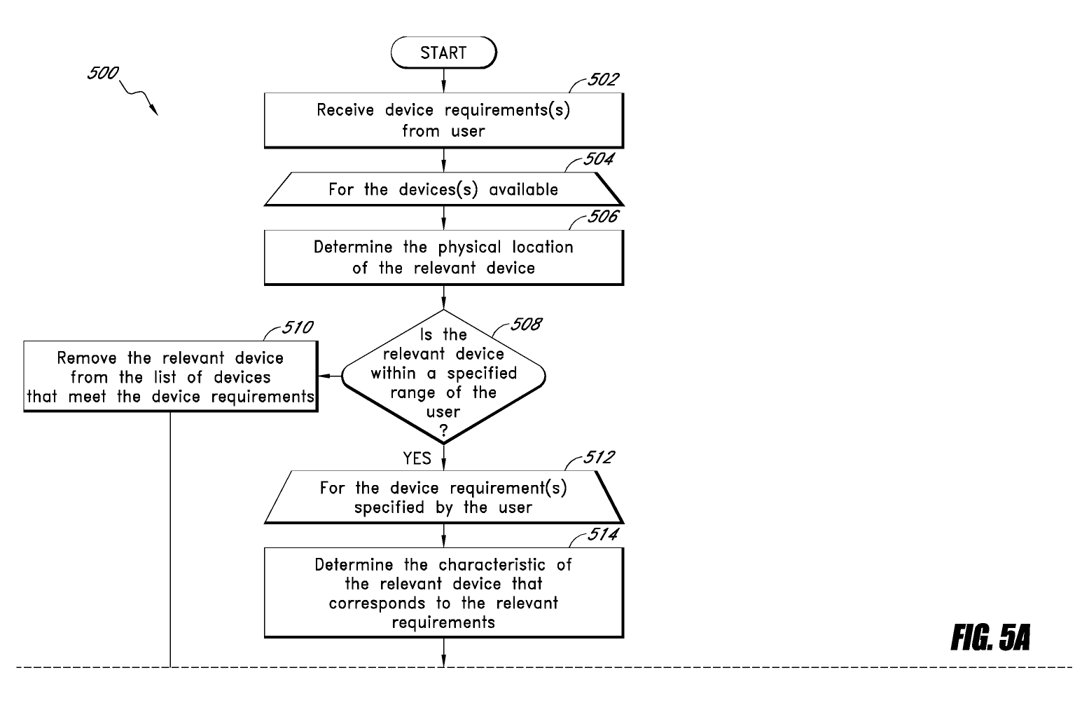

FIG. 4 illustrates one embodiment of a process for dynamically determining the physical location of a networked printing device. In state 402, dynamic location process 400 communicates with the device to determine the physical location of the device. For example, dynamic location process 400 may query the device for its location or may listen for a regular broadcast of its location. In state 404, the dynamic process communicates with device to determine whether the device meets the requirements of the user. In state 406, the dynamic process determines whether the device meets the requirements of the user. Requirements of the user may include requirements based on the capabilities of the device (such as printing, color printing, faxing, scanning, color scanning, and so forth), the cost of the services of the device, and the user permissions of the device. If the device meets the requirements of the user, then the dynamic location process 400 determines the user's physical location, and provides a map to the user for locating the device. If the device does not meet the requirements of the user, the dynamic location process 400 terminates.

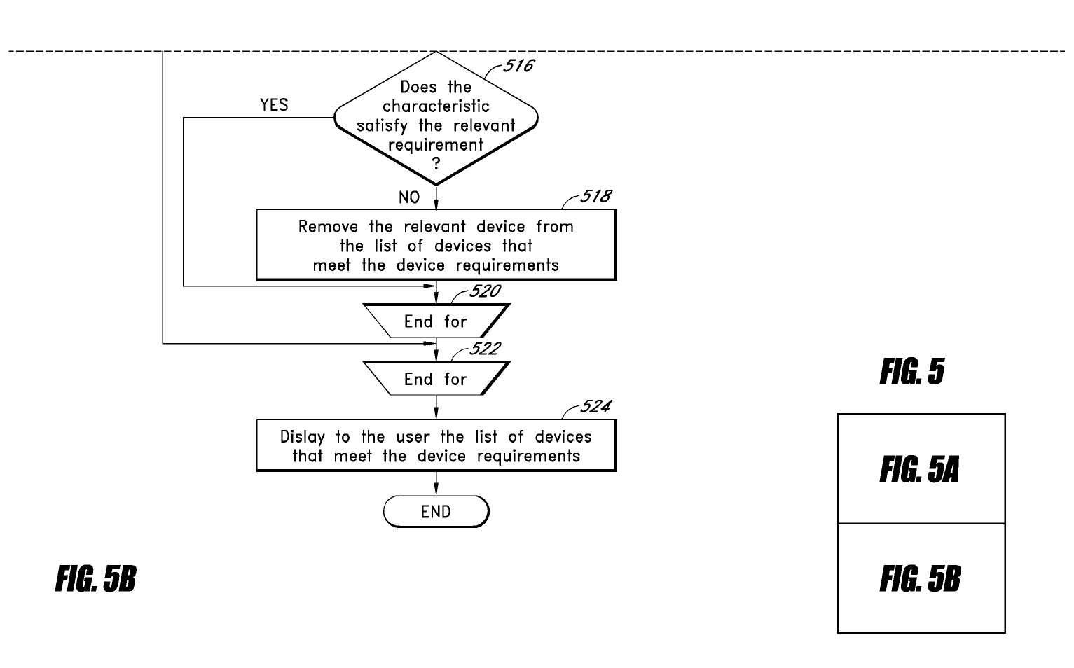

FIG. 5 illustrates one embodiment of a process for generating a list of available devices using dynamic discovery of the physical location of the devices. In state 502, the dynamic list process 500 receives device requirements from a user. The operations between state 504 and state 522 are executed for the devices available to the dynamic process querying the devices. In state 506, the dynamic list process determines the physical location of the relevant device. If the relevant device is within a specified range of the user, as determined in state 506, then the dynamic process proceeds to execute the operations between state 512 and state 520. If the relevant device is not within a specified range of the user, then the dynamic list process proceeds to state 510. In state 510, the dynamic list process 500 removes the relevant device from the list of devices that meet the device requirements. In state 514, the dynamic list process 500 determines the characteristic of the relevant device that corresponds to the relative requirement. If the characteristics satisfy the relevant requirement, as determined in state 516, the dynamic list process 500 proceeds to state 520. If the characteristic is not satisfied for the relevant requirement, then, in state 518, the dynamic list process 500 removes the relevant device from the list of devices that meet the device requirements. Thus, once all of the available devices have been examined to determine whether or not they meet the device requirements, there is a list of only those devices that meet the device requirements. In state 524, the dynamic list process 500 displays the use of the list of devices that meet the device requirements. By using a process, such as dynamic process 400, the dynamic process 500 may also assist users to determine the physical location of each device that meets it requirements.

Although this invention has been described in terms of certain embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

What is claimed is:

1. A method for dynamic discovery of a networked peripheral device, comprising:
determining a physical location of a multifunction peripheral device;
communicating the physical location from the multifunction peripheral device to a recipient computing device;
receiving the physical location at the recipient computing device; and
generating a map based on the physical location of the multifunction device.

2. The method of claim 1, wherein the physical location comprises a longitude and latitude of the multifunction peripheral device.

3. The method of claim 1, wherein determining the physical location comprises using a global positioning system device to determine the physical location.

4. The method of claim 1, wherein communicating the physical location comprises broadcasting the physical location with a radio-frequency identification device.

5. The method of claim 4, wherein the radio-frequency identification device comprises an active RFID device.

6. The method of claim 1, wherein the recipient device comprises one of the following: a desktop, a laptop, a personal digital assistant, a cell phone, an automobile navigation system, a mobile computer, and a server.

7. The method of claim 1, further comprising determining a physical location of the recipient computing device, and generating the map based also on the physical location of the recipient computing device.

8. The method of claim 1, further comprising determining whether the physical location is within an acceptable range of the recipient computing device.

9. The method of claim 1, further comprising communicating at least one device characteristic from the multifunction peripheral device to the recipient computing device, wherein the at least one device characteristic comprises one of the following: capabilities of the multifunction peripheral, cost of services of the multifunction peripheral, permissions to use the multifunction peripheral.

10. The method of claim 9, further comprising determining whether the at least one device characteristic meets a device requirement specified by a user of the recipient computing device.

11. The method of claim 1, wherein generating the map comprises at least one of the following: using a local application to generate the map and using a Web service to request a map.

12. A computer readable medium having instructions stored thereon for dynamic discovery of a networked peripheral device, the instructions comprising:
determining a physical location of a multifunction peripheral device;
communicating the physical location from the multifunction peripheral device to a recipient computing device;
receiving the physical location at the recipient computing device; and
generating a map based on the physical location.

13. A system for dynamic discovery of a networked peripheral device, comprising:
a multifunction peripheral device configured to communicate its physical location; and
a computer readable medium having instructions stored thereon for generating a map based on the physical location of the multifunction peripheral device, the instructions comprising receiving the physical location and generating a map based on the physical location.

14. The system of claim 13, wherein the physical location comprises a longitude and latitude of the multifunction device.

15. The system of claim 13, wherein determining the physical location comprises using a global positioning system device to determine the physical location.

16. The system of claim 13, wherein the multifunction peripheral device comprises a radio-frequency identification device, and wherein the multifunction peripheral device communicates its physical location via the radio-frequency device.

17. The system of claim 13, wherein the radio-frequency device comprises an active RFID device.

18. The system of claim 13, wherein the computer readable medium comprises at least one of the following: a client application executable on a user device; a Web service application executable on a remote device; and an application executable on the multifunction peripheral device.

19. The system of claim 13, generating the map comprises at least one of the following: using a local application to generate the map and using a Web service to request a map.

20. The system of claim 13, wherein the instructions further comprise generating the map also based on the location of a user device.

21. The system of claim 13, wherein the instructions further comprise determining whether the physical location is within an acceptable range of a prospective user of the multifunction peripheral.

22. The system of claim 13, wherein the multifunction peripheral is further configured to communicate at least one device characteristic, wherein the at least one device characteristic comprises one of the following: capabilities of the multifunction peripheral, cost of services of the multifunction peripheral, permissions to use the multifunction peripheral.

23. The system of claim 22, wherein the instructions further comprise determining whether the at least one device characteristic meets a device requirement specified by a prospective user of the multifunction peripheral.

24. A multifunction peripheral device configured to communicate its physical location, comprising:
a chassis housing a plurality of device modules comprising at least one of the following: a printer, a fax module, a scan module, and a copier;
a computer readable medium having data stored thereon for storing the physical location of the chassis; and
a communication module configured to communicate the physical location to a recipient computing device.

25. The multifunctional peripheral of claim 24, wherein the physical location comprises a longitude and latitude of the multifunction device.

26. The multifunctional peripheral of claim 24, further comprising a global positioning system device configured to determine the physical location.

27. The multifunctional peripheral of claim 24, wherein the communication module comprises a radio-frequency identification device.

28. The multifunctional peripheral of claim 24, wherein the radio-frequency identification device comprises an active RFID device.

29. The multifunctional peripheral of claim 24, wherein the communication module is further configured to communicate at least one of the following device characteristics: capabilities of the multifunction peripheral, cost of services of the multifunction peripheral, permissions to use the multifunction peripheral.

30. A method of generating a list of suitable multifunction peripherals, based at least in part on physical locations of multifunctional peripherals available over a network, comprising:
receiving device requirements from a user, wherein the device requirements include an acceptable range of physical distance from the user;
determining a list of available multifunction peripherals from which to determine a list of suitable devices;
eliminating from the list devices that are not within the physical distance specified by the device requirements;
eliminating from the list devices that do not meet the other device requirements; and
sending the list of multifunction peripherals that are within the specified physical distance and that meet the other device requirements.

31. The method of claim 30, wherein eliminating from the list devices that are not within the physical distance specified by the device requirements comprises dynamically determining physical locations of the available multifunction peripherals.
